(19) United States
(12) Patent Application Publication
(10) Pub. No.: US 2015/0315894 A1
(43) Pub. Date: Nov. 5, 2015

(54) MODEL FOR STRENGTHENING FORMATIONS

(71) Applicant: M-I L.L.C., Houston, TX (US)

(72) Inventor: Quanxin Guo, Cambridge (GB)

(21) Appl. No.: 14/675,234

(22) Filed: Mar. 31, 2015

Related U.S. Application Data
(60) Provisional application No. 61/972,765, filed on Mar. 31, 2014.

(51) Int. Cl. E21B 44/00; G06F 17/10; G05B 13/04; E21B 43/16; E21B 49/00

(52) U.S. Cl. CPC E21B 44/00; E21B 43/16; E21B 49/006; G05B 13/048; G06F 17/10

(57) ABSTRACT

Analyzing a well includes receiving an input for the well, calculating a stress of the well using the input, and obtaining fracture information based on the stress of the well. A wellbore strengthening solution for the well is identified using the fracture information. Analyzing the well may further include performing a wellbore operation using the wellbore strengthening solution.

### CROSS-REFERENCE TO RELATED APPLICATIONS

This application claims priority under 35 U.S.C. §119(e) to U.S. Provisional Patent Application Ser. No. 61/972,765, filed on Mar. 31, 2014 and entitled, “MODEL FOR STRENGTHENING FORMATIONS.” U.S. Provisional Patent Application Ser. No. 61/972,765 is incorporated herein by reference in its entirety.

### BACKGROUND

Operations, such as surveying, drilling, wireline testing, completions, production, planning and field analysis, may be performed to locate and gather valuable downhole fluids. Surveys are performed using acquisition methodologies, such as seismic scanners or surveyors to obtain data about underground formations. During drilling and production operations, data may be collected for analysis and/or monitoring of the operations. Such data may include, for instance, information regarding subterranean formations, equipment, historical, and/or other data. Simulators may be used the gathered data to model specific behavior of discrete portions of the wellbore operation.

### SUMMARY

In general, in one aspect, one or more embodiments are directed to analyzing a well. Analyzing a well includes receiving an input for the well, calculating a stress of the well using the input, and obtaining fracture information based on the stress of the well. A wellbore strengthening solution for the well is identified using the fracture information. Analyzing the well may further include performing a wellbore operation using the wellbore strengthening solution.

Other aspects of the invention will be apparent from the following description and the appended claims.

### BRIEF DESCRIPTION OF DRAWINGS

FIGS. 1, 2, 3.1 and 3.2 show example schematic diagrams in accordance with one or more embodiments.

FIGS. 4-6 show example schematics in accordance with one or more embodiments.

FIG. 7 shows an example flowchart in accordance with one or more embodiments.

FIG. 8-10 show example graphs in accordance with one or more embodiments.

FIG. 11 shows an example sandstone block in accordance with one or more embodiments.

FIG. 12 shows an example schematic diagram in accordance with one or more embodiments.

### DETAILED DESCRIPTION

Specific embodiments will now be described in detail with reference to the accompanying FIGS. Like elements in the various FIGs are denoted by like reference numerals for consistency.

In the following detailed description of embodiments, numerous specific details are set forth in order to provide a more thorough understanding. However, it will be apparent to one of ordinary skill in the art that one or more embodiments may be practiced without these specific details. In other instances, well-known features have not been described in detail to avoid unnecessarily complicating the description.

In general, embodiments are directed to drilling a well based on a model. In one or more embodiments, the model may use various types of input, such as a three dimensional earth model, information about overburden pressure, confining pressure, wellbore, stress, pore pressure, type of rock, and/or other information or a combination thereof. In one or more embodiments, the model defines conditions of the well that would cause fracture or bursting of the well. In some embodiments, the model may provide parameters that may be used to drill the well and alleviate the possibility of the well bursting or collapsing. The parameters may include, for example, material in the mud, mud-weight, and techniques for modifying the wellbore and near wellbore rock behavior. Further, the model may be applied to a depleted reservoir. In one or more embodiments, based on the parameters and/or conditions, the well is drilled.

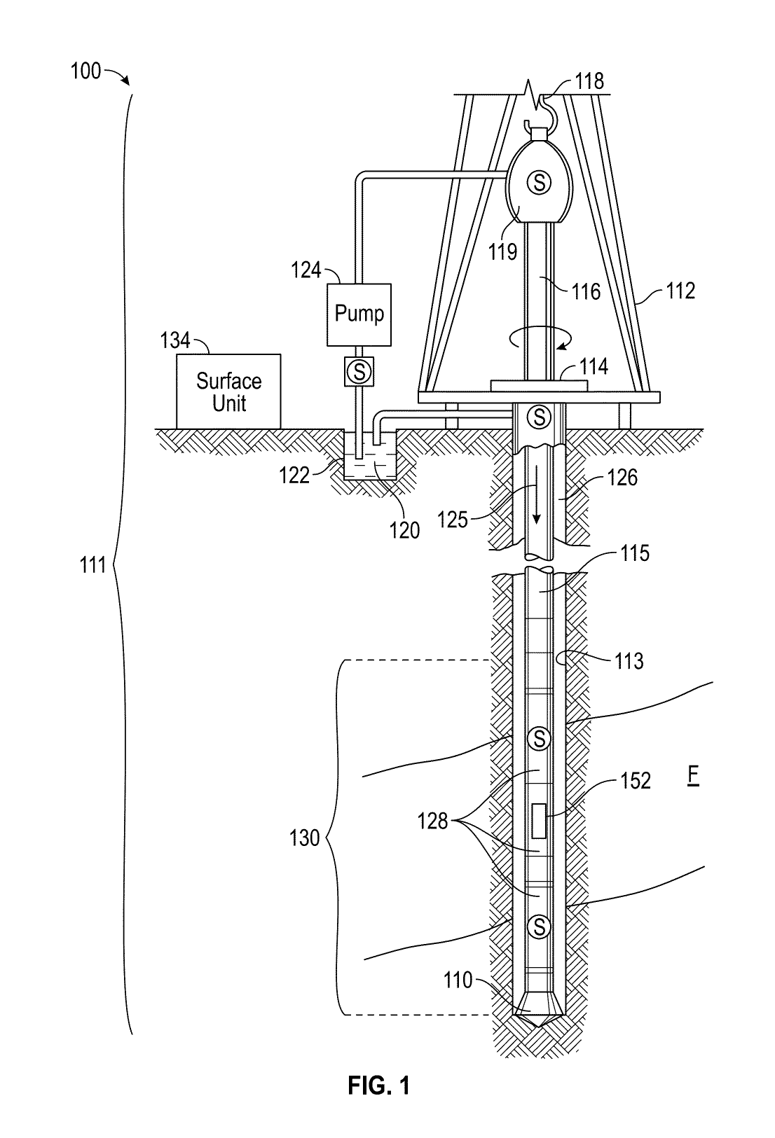

FIG. 1 is a schematic view of a wellsite (100) depicting a drilling operation. In one or more embodiments, drilling tools are deployed from the oil and gas rigs. The drilling tools advanced into the earth along a path to locate reservoirs containing the valuable downhole assets. In one or more embodiments, the optimal path for the drilling is identified using the three dimensional modeling. Specifically, in one or more embodiments, the three dimensional model is partitioned into a three dimensional grid of cells. Each cell may be a cube in the model. In one or more embodiments, a drilling direction is calculated for each cell in the model while accounting for neighboring cells. The path is defined by drilling in the drilling direction from a starting cell to a neighboring cell, then drilling in the drilling direction defined for the neighboring cell to a subsequent neighboring cell, then drilling in the drilling direction for the subsequent neighboring cell to another neighboring cell, etc.

Fluid, such as drilling mud or other drilling fluids, is pumped down the wellbore (or borehole) through the drilling tool and out the drilling bit. In one or more embodiments, the amount of fluid pumped into the well is defined by the drilling density. Specifically, the drilling density is the upper and lower bounds of equivalent hydraulic pressure acting over borehole walls to create failure of the borehole. Because the amount and type of fluid directly affects the hydraulic pressure on the borehole walls, calculating the drilling density and using the drilling density defines the amount and type of fluid to pump down the wellbore. Continuing with the discussion of FIG. 1, the drilling fluid flows through the annulus between the drilling tool and the wellbore and out the surface, carrying away earth loosened during drilling. The drilling fluids return the earth to the surface, and seal the wall of the wellbore to prevent fluid in the surrounding earth from entering the wellbore and causing a ‘blow out’.

During the drilling operation, the drilling tool may perform downhole measurements to investigate downhole conditions. The drilling tool may be used to take core samples of subsurface formations. In some cases, the drilling tool is removed and a wireline tool is deployed into the wellbore to perform additional downhole testing, such as logging or sampling. Steel casing may be run into the well to a desired depth and cemented into place along the wellbore wall. Drilling may be continued until the desired total depth is reached.

A formation is in an underground geological region. An underground geological region is a geographic area that exists below land or ocean. In one or more embodiments, the underground geological region includes the subsurface formation in which a borehole is or may be drilled and any subsurface region that may affect the drilling of the borehole, such as because of stresses and strains existing in the subsurface region. In other words, the underground geological region may include the area immediately surrounding a borehole or where a borehole may be drilled, and also any area that affects or may affect the borehole or where the borehole may be drilled.

After the drilling operation is complete, the well may then be prepared for production. Wellbore completions equipment is deployed into the wellbore to complete the well in preparation for the production of fluid through the wellbore. Fluid is then allowed to flow from downhole reservoirs, into the wellbore and to the surface. Production facilities are positioned at surface locations to collect the hydrocarbons from the wellsite(s). Fluid drawn from the subterranean reservoir(s) passes to the production facilities via transport mechanisms, such as tubing. Various equipment may be positioned about the oilfield to monitor oilfield parameters, to manipulate the oilfield operations and/or to separate and direct fluids from the wells. Surface equipment and completion equipment may also be used to inject fluids into reservoir either for storage or at strategic points to enhance production of the reservoir.

During the oilfield operations, data may be collected for analysis and/or monitoring of the oilfield operations. Such data may include, for example, subterranean formation, equipment, historical and/or other data. Data concerning the subterranean formation is collected using a variety of sources. Such formation data may be static or dynamic. Static data relates to, for example, formation structure and geological stratigraphy that define the geological structures of the subterranean formation. Dynamic data relates to, for example, fluids flowing through the geologic structures of the subterranean formation over time. Such static and/or dynamic data may be collected to learn more about the formations and the valuable assets contained therein. Specifically, the static and dynamic data collected from the wellbore and the oilfield may be used to create and update the three dimensional model. Additionally, static and dynamic data from other wellbores or oilfields may be used to create and update the three dimensional model. Hardware sensors, core sampling, and well logging techniques may be used to collect the data. Other static measurements may be gathered using downhole measurements, such as core sampling and well logging techniques. Well logging involves deployment of a downhole tool into the wellbore to collect various downhole measurements, such as density, resistivity, etc., at various depths. Such well logging may be performed using, for example, the drilling tool and/or a wireline tool. Once the well is formed and completed, fluid flows to the surface using production tubing and other completion equipment. As fluid passes to the surface, various dynamic measurements, such as fluid flow rates, pressure, and composition may be monitored. These parameters may be used to determine various characteristics of the subterranean formation.

Continuing with FIG. 1, the wellsite system (100) includes a drilling system (111) and a surface unit (134). In the illustrated embodiment, a borehole (113) is formed by rotary drilling in a manner that is well known. Although rotary drilling is shown, embodiments also include drilling applications other than conventional rotary drilling (e.g., mud-motor based directional drilling), and is not limited to land-based rigs. For example, embodiments may be used to perform three dimensional modeling and drilling of a deep water operation.

The drilling system (111) includes a drill string (115) suspended within the borehole (113) with a drill bit (110) at its lower end. The drilling system (111) also includes the land-based platform and derrick assembly (112) positioned over the borehole (113) penetrating a subsurface formation (F). The assembly (112) includes a rotary table (114), kelly (116), hook (118) and rotary swivel (119). The drill string (115) is rotated by the rotary table (114), energized by means not shown, which engages the kelly (116) at the upper end of the drill string. The drill string (115) is suspended from hook (118), attached to a traveling block (also not shown), through the kelly (116) and a rotary swivel (119) which permits rotation of the drill string relative to the hook.

The drilling system (111) further includes drilling fluid or mud (120) stored in a pit (122) formed at the well site. A pump (124) delivers the drilling fluid (120) to the interior of the drill string (115) via a port in the swivel (119), inducing the drilling fluid to flow downwardly through the drill string (115) as indicated by the directional arrow (125). The drilling fluid exits the drill string (115) via ports in the drill bit (110), and then circulates upwardly through the region between the outside of the drill string and the wall of the borehole, called the annulus (126). In this manner, the drilling fluid lubricates the drill bit (110) and carries formation cuttings up to the surface as it is returned to the pit (122) for recirculation.

The drill string (115) further includes a bottom hole assembly (BHA), generally referred to as (130), near the drill bit (110) (in other words, within several drill collar lengths from the drill bit). The bottom hole assembly (130) includes capabilities for measuring, processing, and storing information, as well as communicating with the surface unit. The BHA (130) further includes drill collars (128) for performing various other measurement functions.

Sensors (S) are located about the wellsite to collect data, may be in real time, concerning the operation of the wellsite, as well as conditions at the wellsite. The sensors may also have features or capabilities, of monitors, such as cameras (not shown), to provide pictures of the operation. Surface sensors or gauges S may be deployed about the surface systems to provide information about the surface unit, such as standpipe pressure, hook load, depth, surface torque, and/or rotary rpm, among others. Downhole sensors or gauges (S) are disposed about the drilling tool and/or wellbore to provide information about downhole conditions, such as wellbore pressure, weight on bit, torque on bit, direction, inclination, collar rpm, tool temperature, annular temperature, and toolface, among others. The information collected by the sensors and cameras is conveyed to the various parts of the drilling system and/or the surface control unit.

The drilling system (110) is operatively connected to the surface unit (134) for communication therewith. The BHA (130) is provided with a communication subassembly (152) that communicates with the surface unit (134). The communication subassembly (152) is adapted to send signals to and receive signals from the surface using mud pulse telemetry. The communication subassembly may include, for example, a transmitter that generates a signal, such as an acoustic or electromagnetic signal, which is representative of the measured drilling parameters. Communication between the downhole and surface systems is depicted as being mud pulse telemetry. However, a variety of telemetry systems may be employed, such as wired drill pipe, electromagnetic or other known telemetry systems.

The wellbore may be drilled according to a drilling plan that is established prior to drilling. The drilling plan may set forth equipment, pressures, trajectories and/or other parameters that define the drilling process for the wellsite. The drilling operation may then be performed according to the drilling plan. However, as information is gathered, the drilling operation may deviate from the drilling plan. Additionally, as drilling or other operations are performed, the subsurface conditions may change. The three dimensional model may also be adjusted as new information is collected, such as from sensors. Specifically, as new information is collected, the sensors may transmit data to the surface unit. The surface unit may automatically use the data to update the three dimensional model.

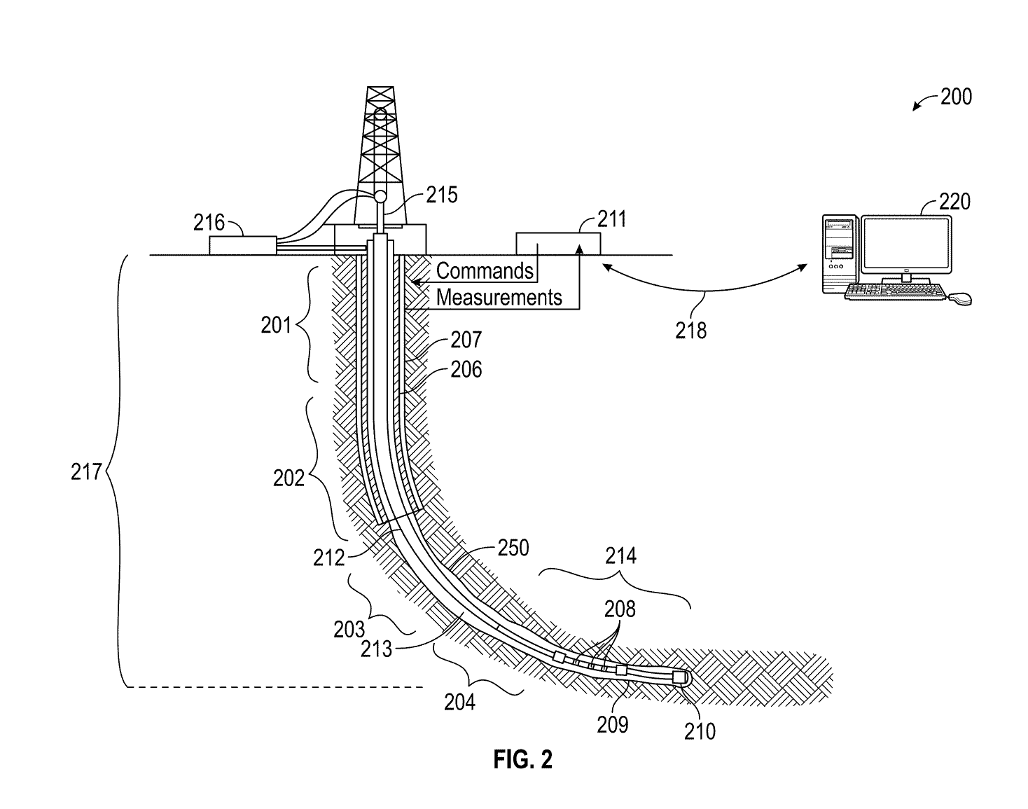

FIG. 2 shows a schematic diagram depicting drilling operation of a directional well in multiple sections. The drilling operation depicted in FIG. 2 includes a wellsite drilling system (200) and a computer system (220) for accessing fluid in the target reservoir through a bore hole (250) of a directional well (217). The wellsite drilling system (200) includes various components (e.g., drill string (212), annulus (213), bottom hole assembly (BHA) (214), Kelly (215), mud pit (216), etc.) as generally described with respect to the wellsite drilling systems (100) (e.g., drill string (115), annulus (126), bottom hole assembly (BHA) (130), Kelly (116), mud pit (122), etc.) of FIG. 1 above. As shown in FIG. 2, the target reservoir may be located away from (as opposed to directly under) the surface location of the well (217). Accordingly, special tools or techniques may be used to ensure that the path along the bore hole (250) reaches the particular location of the target reservoir (200).

For example, the BHA (214) may include sensors (208), rotary steerable system (209), and the bit (210) to direct the drilling toward the target guided by a pre-determined survey program for measuring location details in the well. Furthermore, the subterranean formation through which the directional well (217) is drilled may include multiple layers (not shown) with varying compositions, geophysical characteristics, and geological conditions. Both the drilling planning during the well design stage and the actual drilling according to the drilling plan in the drilling stage may be performed in multiple sections (e.g., sections (201), (202), (203), (204)) corresponding to the multiple layers in the subterranean formation. For example, certain sections (e.g., sections (201) and (202)) may use cement (207) reinforced casing (206) due to the particular formation compositions, geophysical characteristics, and geological conditions.

Further as shown in FIG. 2, surface unit (211) (as generally described with respect to the surface unit (134) of FIG. 1) may be operatively linked to the wellsite drilling system (200) and the computer system (220) via communication links (218). The surface unit (211) may be configured with functionalities to control and monitor the drilling activities by sections in real-time via the communication links (218). The computer system (220) may be configured with functionalities to store oilfield data (e.g., historical data, actual data, surface data, subsurface data, equipment data, geological data, geophysical data, target data, anti-target data, etc.) and determine relevant factors for configuring a drilling model and generating a drilling plan. The oilfield data, the drilling model, and the drilling plan may be transmitted via the communication link (218) according to a drilling operation workflow. The communication link (218) may comprise the communication subassembly (352) as described with respect to FIG. 1 above.

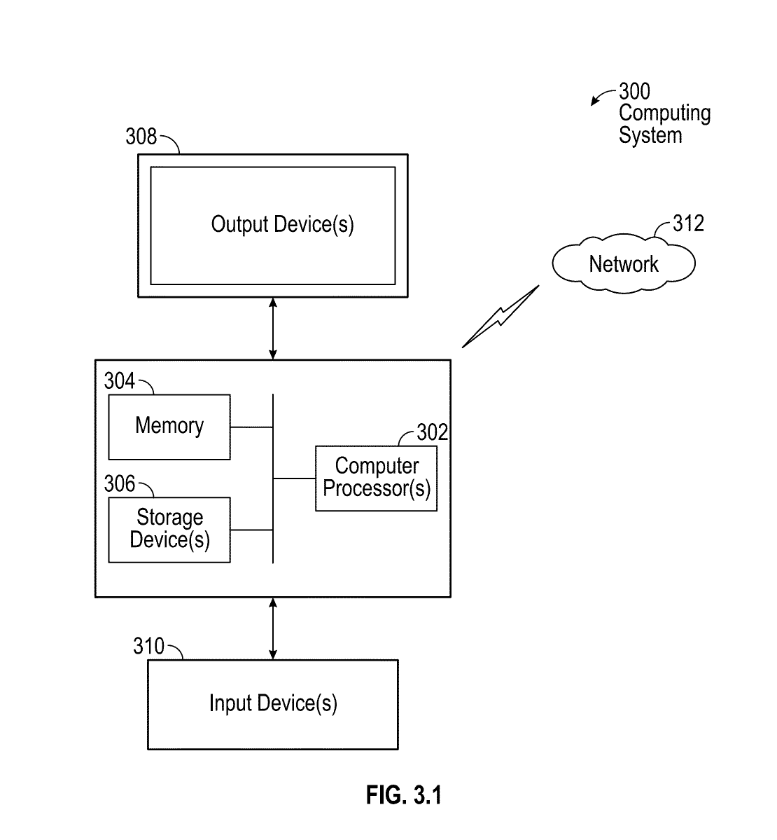

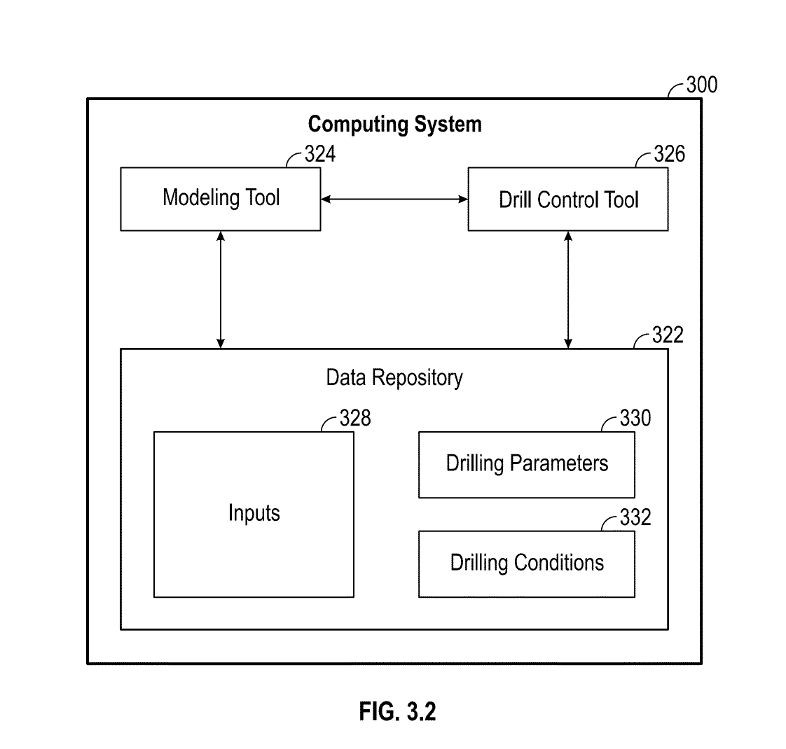

The computer system and/or surface unit may be virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 3.1, the computing system (300) may include one or more computer processor(s) (302), associated memory (304) (e.g., random access memory (RAM), cache memory, flash memory, etc.), one or more storage device(s) (306) (e.g., a hard disk, an optical drive such as a compact disk (CD) drive or digital versatile disk (DVD) drive, a flash memory stick, etc.), and numerous other elements and functionalities. The computer processor(s) (302) may be an integrated circuit for processing instructions. For example, the computer processor(s) may be one or more cores, or micro-cores of a processor. The computing system (300) may also include one or more input device(s) (310), such as a touchscreen, keyboard, mouse, microphone, touchpad, electronic pen, or any other type of input device. Further, the computing system (300) may include one or more output device(s) (308), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (300) may be connected to a network (314) (e.g., a local area network (LAN), a wide area network (WAN) such as the Internet, mobile network, or any other type of network) via a network interface connection (not shown). The input and output device(s) may be locally or remotely (e.g., via the network (312)) connected to the computer processor(s) (302), memory (304), and storage device(s) (306). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system (300) may be located at a remote location and connected to the other elements over a network (314). Further, embodiments may be implemented on a distributed system having a plurality of nodes, where each portion may be located on a different node within the distributed system. In one embodiment, the node corresponds to a distinct computing device. The node may correspond to a computer processor with associated physical memory. The node may correspond to a computer processor or micro-core of a computer processor with shared memory and/or resources.

FIG. 3.2 shows another schematic diagram of the computing system (300) in accordance with one or more embodiments. As shown in FIG. 3.2, the computing system may include a data repository (322), a modeling tool (324), and a drill control tool (326). The data repository (322) is any type of storage unit and/or device (e.g., a file system, database, collection of tables, or any other storage mechanism) for storing data. Further, the data repository (322) may include multiple different storage units and/or devices. The multiple different storage units and/or devices may or may not be of the same type or located at the same physical site.

The data repository (322) may include functionality to store inputs (328), drilling parameters (330), and drilling conditions (332). The inputs (328) may include any type of input to the modeling tool (324). For example, the inputs may include data collected from processed and/or processed data from sensors, other models (e.g., three dimensional earth models), information gathered from other wells, any other information, or a combination thereof. The processed and/or processed data from sensors may include data gathered during the planning, drilling, completion and/or production stages of a well. The drilling parameters (330) may be output of the model that defines how to drill the well to alleviate the possibility of bursting or collapsing of the well. For example, the drilling parameters may include material in the mud, mud-weight, and techniques for modifying the wellbore and near wellbore rock behavior, any other information, or a combination thereof. The drilling conditions (332) are conditions of the well that may cause fracture or bursting of the well. For example, the drilling conditions (332) may include the maximal stresses that the rock surrounding the well is capable of handling, and other information.

As shown in FIG. 3.2, the data repository (322) is operatively connected to a modeling tool (324) and drill control tool (326) in accordance with one or more embodiments. The modeling tool (324) is a hardware, software, firmware, or combination thereof tool that includes functionality to model the well and to determine drilling parameters and drilling conditions. The drill control tool (326) is a hardware, software, firmware, or combination thereof tool that includes functionality to directly or indirectly control drilling operations at the wellsite. For example, the drill control tool (326) may include functionality to display or otherwise present the drilling conditions and/or parameters to a drill operator or another individual, adjust the actions of the drilling tools, and/or perform any other operations to control the drilling operations at the wellsite.

While FIGS. 1, 2, 3.1, and 3.2 show a configuration of components, other configurations may be used without departing from the scope. For example, various components may be combined to create a single component. As another example, the functionality performed by a single component may be performed by two or more components.

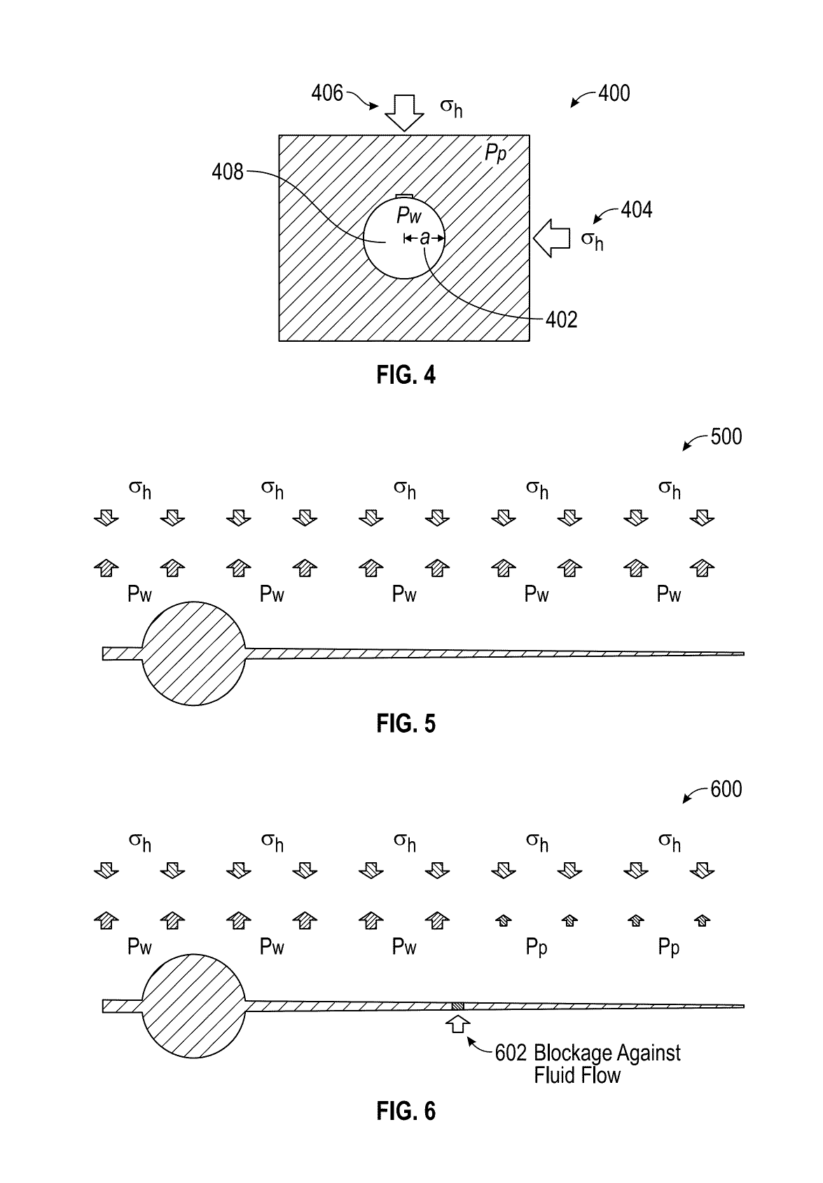

FIG. 4 shows an example schematic (400) of rock mechanics on fracture initiation and propagation that may be used by the modeling tool. Specifically, FIG. 4 shows an example schematic of a vertical wellbore under in-situ stresses, formation and wellbore pressures. In FIG. 4, a vertical well is drilled through this formation with a bit size of 2α (402). In the rock mechanics, the fractures may initiate at the drill bit immediately when the rock is exposed to fluids or behind the bit. The following is a discussion for fractures that initiate behind the bit. The problem may be approximated as a vertical well under the minimum and maximum horizontal stresses σₕ (406) and σ_{H} (404), and pore pressure of Pₚ (408).

The hoop-stress at the wellbore may be given by Eq. (1)

σ_{θ}=3σₕ−σ_{H}−P_{W} (1)

If fractures initiate when the effective hoop stress reaches the tensile strength (−T) of the rock, then the fracture initiation pressure for the case of no or little mud filtration into the rock (either due to short time, or tight filter-cake or any other means of near-wellbore fluid and rock property alterations), fractures will form when the wellbore pressure (P_{W}) or Equivalent Circulating Density (ECD) reaches

P_{W}=3σₕ−σ_{H}−Pₚ+T (2)

The above equation may be simplified by assuming σₕ=σ_{H} and T=0. The fracture initiation pressure may then be determined if the wellbore pressure may be isolated from the formation pressure as shown in the following.

P_{W}=2σₕ−Pₚ (3)

If a good filter-cake or plug micro-fractures cannot be formed to isolate the wellbore pressure from the formation pressure, then Pₚ=P_{w} near the wellbore and the fracture initiation pressure becomes

P_{W}=σₕ (4)

Based on Eq. 2, because the fracture propagation pressure (σₕ) is much smaller than the fracture initiation pressure given by Eq. (3), the wellbore may be strengthened by isolating the wellbore from the rock formation. The fracture initial pressure may be increased if a drilling fluid solution is engineered and used to prevent mud penetration into a highly permeable formation and isolate near wellbore formation pressure from wellbore pressure. The engineered drilling fluid may be effective for highly depleted formation when pore pressure Pₚ is small.

The above are examples of equations and assumptions that may be used by the modeling tool. Other examples or assumptions may be used without departing from the scope of one or more embodiments.

FIG. 5 shows an schematic (500) of fracture propagation when no blockage of the fracture exists. In other words, FIG. 5 shows the case of a large fracture without any blockage. Without any blockage, the fracture will propagate when the wellbore stress reaches the minimum in-situ stress (σₕ). FIG. 6 shows an example schematic (600) of fracture propagation when a blockage (602) of the fracture exists. However, if the fracture tip is from the wellbore by a blockage (FIG. 6), the wellbore pressure can be increased above the minimum in-situ stress (σₕ) without causing fracture propagation or mud loss. The fracture may grow to a certain length and then become rested.

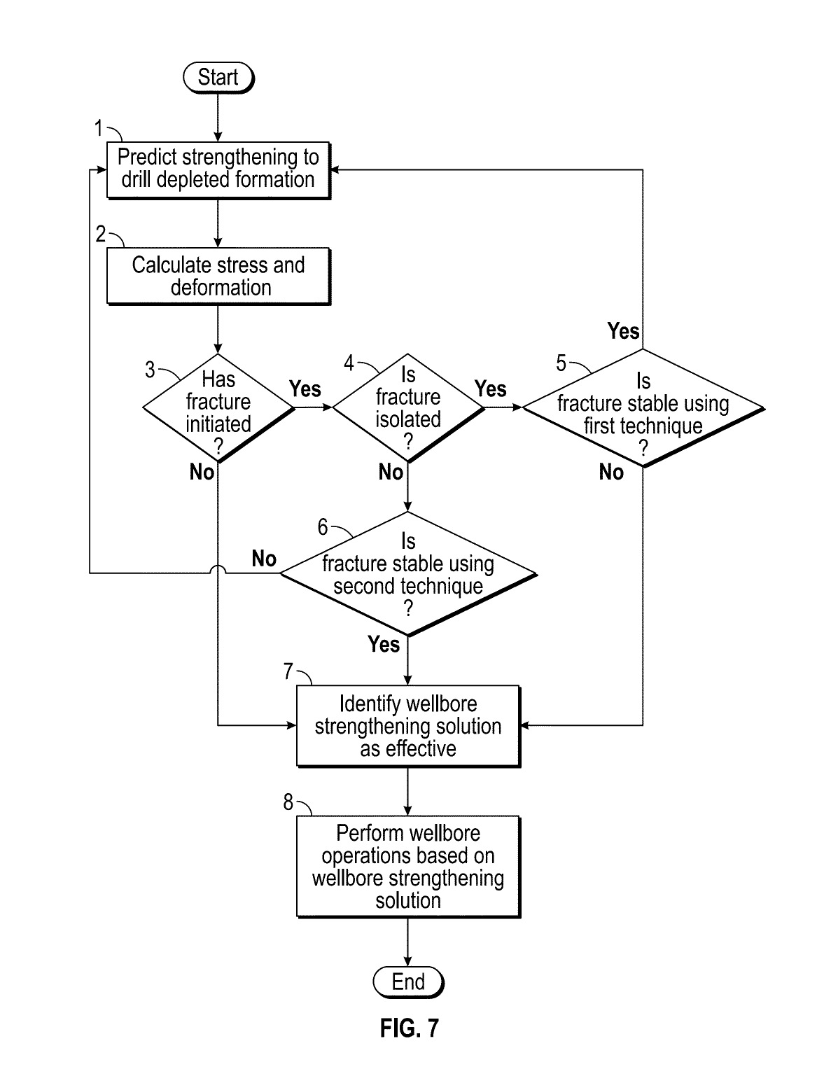

FIG. 7 shows a flowchart in accordance with one or more embodiments. While the various boxes in this flowchart are presented and described sequentially, one of ordinary skill will appreciate that at least some of the boxes may be executed in different orders, may be combined or omitted, and at least some of the boxes may be executed in parallel. Furthermore, the various boxes may be performed actively or passively. For example, determination boxes may not require a processor to process an instruction unless an interrupt is received to signify that condition exists in accordance with one or more embodiments. As another example, determination boxes may be performed by performing a test, such as checking a data value to test whether the value is consistent with the tested condition in accordance with one or more embodiments.

In Box 1, strengthening to drill a depleted formation is predicted in accordance with one or more embodiments. In one or more embodiments, based on data and information of the formation to be drilled, drilling plan and reservoir, the prediction or evaluation of how much strengthening is appropriate to drill the depleted formation safely may be performed. The prediction or estimation may be performed numerically using earth model or analytical model. The amount of strengthening, and the information of rock property modification by chemicals in the mud, fluids, drill bit or special tools, depletion and other formation properties may be used as input to the modeling tool.

In Box 2, stress and deformation may be calculated in accordance with one or more embodiments. In one or more embodiments, the stresses and deformation near the wellbore may then be calculated, either numerically based on earth model or analytically. For example, equations (1) through (4) or other equations may be used.

In Boxes 3, 4, 5, and 6, fracture information is obtained. In Box 3, a determination is made whether fracture initiation may result in accordance with one or more embodiments. Specifically, using the stress and deformation state around the wellbore is known, the modeling tool may predict whether fractures will be generated. Fracture initiation may be determined by a fracture initiation criterion, such as fracture toughness, fracture surface energy or other rock strength parameters, or a combination thereof. Experimental tests may be performed to select and validate the fracture initiation criterion. If the rock, together with chemical and tool solutions, is strong enough to prevent from fracturing, the no mud loss is expected and the wellbore strengthening solution is a success and the method may proceed to Box 7. Otherwise, the method may proceed to Box 4.

In Box 4, a determination is made whether the fracture isolated from wellbore. Specifically, if fracture(s) is generated, then whether the fracture is stable is predicted so that no big mud loss is expected. Determining whether the fracture is stable may include predicting whether the fracture is isolated from the wellbore which is full of drilling fluids. Isolation of fracture from wellbore may be enhanced by chemical and/or mechanical methods through drilling fluids design. A database and knowledge may be used to determine whether or not the fracture is isolated from the wellbore. Next, a determination is made whether the fracture will be stable or not. If the fracture is stable, then no large mud loss is expected and the wellbore strengthening solution is a success and the flow may proceed to Box 7. Otherwise, the solution may be changed and the method may restart with Box 1.

In each of Box 5 and 6, a determination is made whether the fracture is stable. The technique used to determine whether the fracture is stable may be dependent on whether the fracture is isolated from the wellbore. Determining whether a fracture is stable may be performed numerically or analytically. In some embodiments a numerical solution may provide greater accuracy and the entire fracture growth process. The benefits of analytical solutions may include simplicity and ease for parametric studies.

The following is just one example to illustrate the process. One or more embodiments may use other techniques not shown or discussed below.

In Box 5, if the fracture is isolated from the wellbore, then determining whether the fracture is stable may be performed using a first technique. For example, the first technique may be the following equation (5).

K_{I}=P_{W}\sqrt{πL}{(1−λₚ)(1−s)[0.637+0.485(1−s)²+0.4s²(1−s)]+λₚ[1+(1−s)[0.5+0.743(1−s)²]]}−Sₕ\sqrt{πL}{0.5(1−λₛ)(3−s)[1+1.243(1−s)³]+λₛ+λₛ(1−s)[0.5+0.743(1−s)²]} (5)

In the above equation (5), K_{I} is the stress intensity factor of the fracture, P_{w} is the wellbore pressure, L is the fracture length from the wellbore, s=L/(R+L), λₛ=S_{H}/Sₕ, λₚ=Pₚₒᵣₑ/P_{w}, R is the wellbore radius, Sₕ is the minimum in-situ stress, S_{H} is the maximum horizontal in-situ stress, Pₚₒᵣₑ is the pore pressure.

In Box 6, if the fracture is not isolated from the wellbore, then determining whether the fracture is stable may be performed using a second technique. For example, the second technique may be the following equation (6).

K_{I}=P_{W}\sqrt{πL}[1+(1−s)[0.5+0.743(1−s)²]]−Sₕ\sqrt{πL}{(1−λ)×0.5(3−s)[1+1.243(1−s)³]+λ+λ(1−s)[0.5+0.743(1−s)²]} (6)

In Box 7, the wellbore strengthening solution is identified as effective in one or more embodiments. Based on the wellbore strengthening solution, wellbore operations may be performed in Box 8. The wellbore operations may include presenting the wellbore strengthening solution and/or adjusting drilling operations at the wellbore. Other wellbore operations may be performed without departing from the scope.

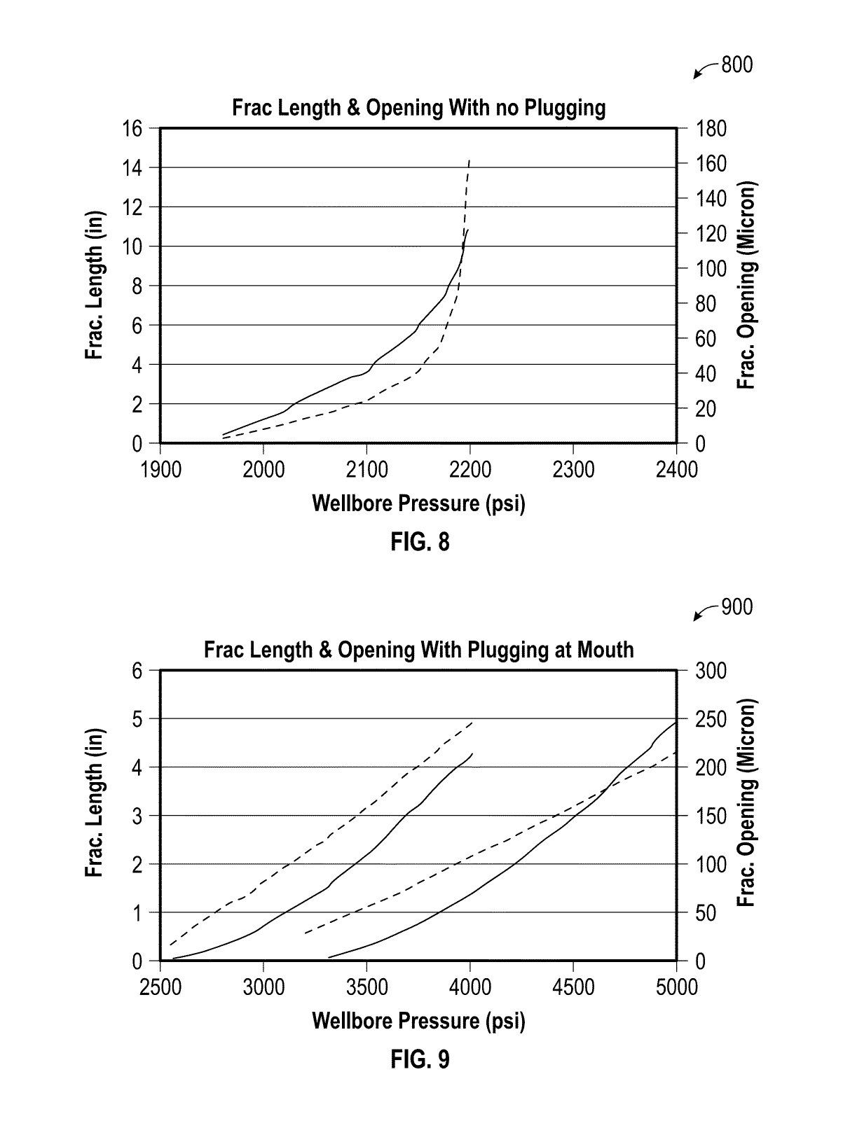

FIG. 8 and FIG. 9 show example graphs (800, 900) comparing the case when the fracture is isolated by seal or filter-cake at the wellbore and the case when no blockage exists. Specifically, FIG. 8 shows fracture length and opening versus wellbore pressure for the case in which no fracture plugging exists. As shown in FIG. 8, when the wellbore pressure approaches the minimum in-situ stress (2200 pounds per square inch (psi)), fracture growth becomes uncontrolled. FIG. 9 shows fracture length and opening versus wellbore pressure for the case the fracture is plugged at the wellbore. As shown in FIG. 9, the wellbore pressure may be increased greatly beyond the minimum in-situ stress (2200 psi) without causing much fracture growth. Further, the fracture opening may be much smaller as well. As predicted by the model, when no blockage exists, wellbore pressure cannot be supported beyond the minimum in-situ stress (2200 psi in this case). When the fracture is sealed at the wellbore, the wellbore pressure may be increased to almost 4000 psi without causing much fracture growth. Further, the fracture opening may be much reduced. Depletion makes this effect even more pronounced (FIG. 9).

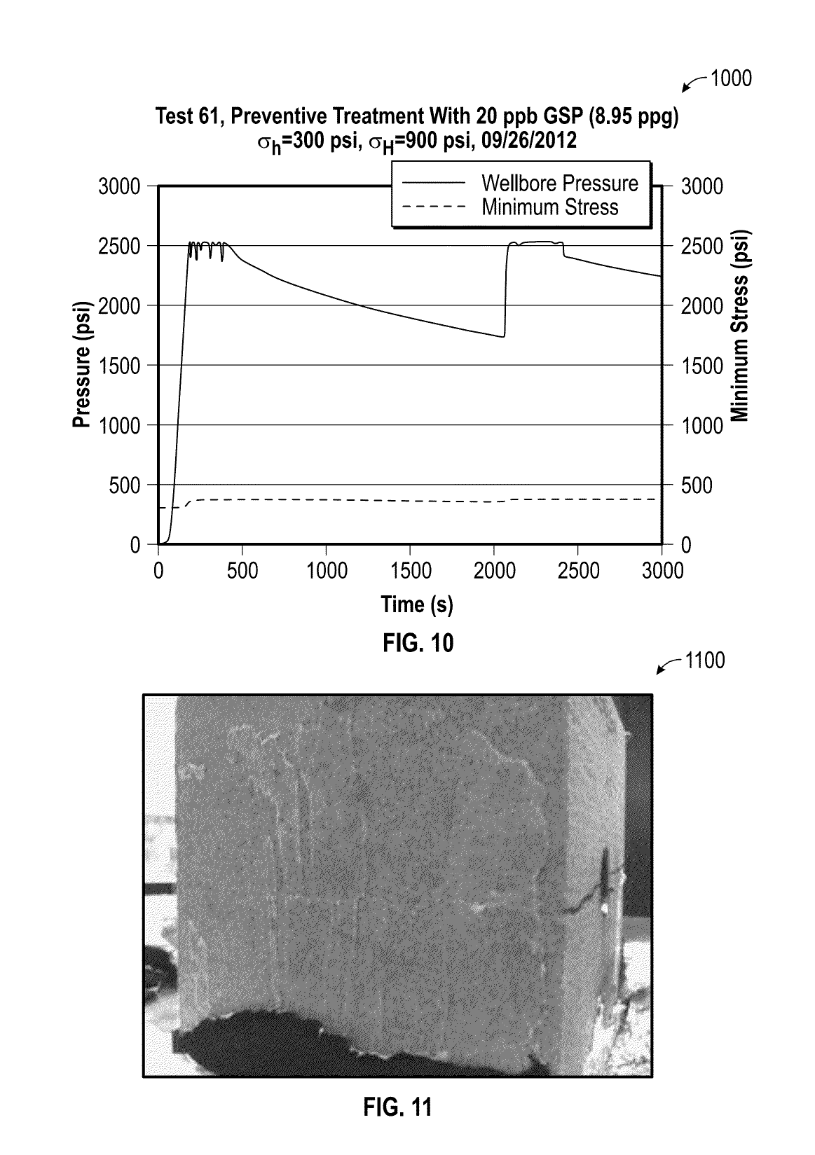

Model prediction of the blockage effect is validated from experimental study shown in FIG. 10 and FIG. 11. Specifically, FIG. 10 shows an example graph (1000) of wellbore pressure versus time in a block test to simulate wellbore strengthening Although no mud loss exists in FIG. 10, fractures were generated. FIG. 11 shows the sandstone block (1100) after the test shown in FIG. 8. As shown in the sandstone block, fractures were generated, but the fracture was sealed near the wellbore and there was no mud loss.

As the pressure in sands is reduced or depleted, the support from the depleted rock to the formation above is reduced or the formation above the depleted formation comes down and becomes “stretched”. When the shale above the depleted formation becomes “stretched”, fracture initiation and propagation pressures are reduced. This has been observed in the field and can be modeled.

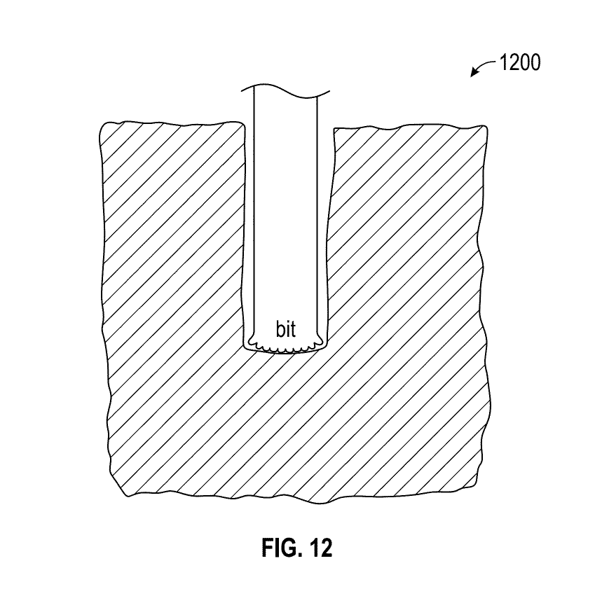

Stress distribution at or near the bit may be different from far behind the bit. Stress distribution far behind the bit may be approximately by a 2-dimentional model as shown schematically in FIG. 8 and FIG. 9. Stress distribution at or near the bit may be considered by a fully 3-dimensional model (1200 in FIG. 12) and may be analyzed using numerical models. The transition, fracture generation, propagation and sealing may depend on ROP or any stabilization solution should become effective before it is too late. In particular, FIG. 12 shows schematic of difference between at or near bit and far behind bit, and thus rate of penetration (ROP) effects.

While the various aspects disclosed herein have been described with respect to a limited number of embodiments, those skilled in the art, having benefit of this disclosure, will appreciate that other embodiments can be devised which do not depart from the scope as disclosed herein. Accordingly, the scope should be limited by the attached claims.

What is claimed is:

1. A method for analyzing a well comprising:
receiving an input for the well;
calculating a stress of the well using the input;
obtaining fracture information based on the stress of the well;
identifying a wellbore strengthening solution for the well using the fracture information; and
performing a wellbore operation using the wellbore strengthening solution.

2. The method of claim 1, wherein obtaining fracture information comprises:
predicting whether a fracture is generated based on the stress and a deformation state around the well.

3. The method of claim 2, wherein obtaining fracture information comprises:
determining whether the facture is stable.

4. The method of claim 3, wherein obtaining fracture information comprises:
determining whether the facture is isolated from the well.

5. The method of claim 4, wherein, when the facture is isolated, determining whether the fracture is stable comprises calculating:
K_{I}=P_{W}\sqrt{πL}{(1−λₚ)(1−s)[0.637+0.485(1−s)²+0.4s²(1−s)]+λₚ[1+(1−s)[0.5+0.743(1−s)²]]}−Sₕ\sqrt{πL}{0.5(1−λₛ)(3−s)[1+1.243(1−s)³]+λₛ+λₛ(1−s)[0.5+0.743(1−s)²]},
wherein K_{I} is a stress intensity factor of the fracture, P_{w} is a wellbore pressure, L is a fracture length from a wellbore, s=L/(R+L), λₛ=S_{H}/Sₕ, λₚ=Pₚₒᵣₑ/P_{w}, R is a wellbore radius, Sₕ is a minimum in-situ stress, S_{H} is a maximum horizontal in-situ stress, and Pₚₒᵣₑ is a pore pressure.

6. The method of claim 4, wherein, when the facture is not isolated, determining whether the fracture is stable comprises calculating:
K_{I}=P_{W}\sqrt{πL}[1+(1−s)[0.5+0.743(1−s)²]]−Sₕ\sqrt{πL}{(1−λ)×0.5(3−s)[1+1.243(1−s)³]+λ+λ(1−s)[0.5+0.743(1−s)²]}
wherein K_{I} is a stress intensity factor of the fracture, P_{w} is a wellbore pressure, L is a fracture length from a wellbore, s=L/(R+L), λₛ=S_{H}/Sₕ, λₚ=Pₚₒᵣₑ/P_{w}, R is a wellbore radius, Sₕ is a minimum in-situ stress, S_{H} is a maximum horizontal in-situ stress, and Pₚₒᵣₑ is a pore pressure.

7. The method of claim 1, wherein obtaining fracture information comprises:
determining fracture initiation using a rock strength parameter and the wellbore strengthening solution.

8. A system for analyzing a well comprising:
a data repository comprising an input for the well;
a modeling tool operatively connected to the data repository and configured to:
calculate a stress of the well using the input,
obtain fracture information based on the stress of the well, and
identify a wellbore strengthening solution for the well using the fracture information; and
a drill control tool operatively connected to the data repository and configured to:
perform a wellbore operation using the wellbore strengthening solution.

9. The system of claim 8, wherein obtaining fracture information comprises:
predicting whether a fracture is generated based on the stress and a deformation state around the well.

10. The system of claim 9, wherein obtaining fracture information comprises:
determining whether the facture is stable.

11. The system of claim 10, wherein obtaining fracture information comprises:
determining whether the facture is isolated from the well.

12. The system of claim 11, wherein, when the facture is isolated, determining whether the fracture is stable comprises calculating:
K_{I}=P_{W}\sqrt{πL}{(1−λₚ)(1−s)[0.637+0.485(1−s)²+0.4s²(1−s)]+λₚ[1+(1−s)[0.5+0.743(1−s)²]]}−Sₕ\sqrt{πL}{0.5(1−λₛ)(3−s)[1+1.243(1−s)³]+λₛ+λₛ(1−s)[0.5+0.743(1−s)²]},
wherein K_{I} is a stress intensity factor of the fracture, P_{w} is a wellbore pressure, L is a fracture length from a wellbore, s=L/(R+L), λₛ=S_{H}/Sₕ, λₚ=Pₚₒᵣₑ/P_{w}, R is a wellbore radius, Sₕ is a minimum in-situ stress, S_{H} is a maximum horizontal in-situ stress, and Pₚₒᵣₑ is a pore pressure.

13. The system of claim 11, wherein, when the facture is not isolated, determining whether the fracture is stable comprises calculating:
K_{I}=P_{W}\sqrt{πL}[1+(1−s)[0.5+0.743(1−s)²]]−Sₕ\sqrt{πL}{(1−λ)×0.5(3−s)[1+1.243(1−s)³]+λ+λ(1−s)[0.5+0.743(1−s)²]}
wherein K_{I} is a stress intensity factor of the fracture, P_{w} is a wellbore pressure, L is a fracture length from a wellbore, s=L/(R+L), λₛ=S_{H}/Sₕ, λₚ=Pₚₒᵣₑ/P_{w}, R is a wellbore radius, Sₕ is a minimum in-situ stress, S_{H} is a maximum horizontal in-situ stress, and Pₚₒᵣₑ is a pore pressure.

14. The system of claim 8, wherein obtaining fracture information comprises:
determining fracture initiation using a rock strength parameter and the wellbore strengthening solution.

15. A non-transitory computer readable medium comprising computer readable program code embodied therein for causing a computer system to:
receive an input for the well;
calculate a stress of the well using the input;
obtain fracture information based on the stress of the well;
identify a wellbore strengthening solution for the well using the fracture information; and
perform a wellbore operation using the wellbore strengthening solution.

16. The non-transitory computer readable medium of claim 15, wherein obtaining fracture information comprises:
predicting whether a fracture is generated based on the stress and a deformation state around the well.

17. The non-transitory computer readable medium of claim 16, wherein obtaining fracture information comprises:
determining whether the facture is stable.

18. The non-transitory computer readable medium of claim 17, wherein obtaining fracture information comprises:
determining whether the facture is isolated from the well.

19. The non-transitory computer readable medium of claim 18, wherein, when the facture is isolated, determining whether the fracture is stable comprises calculating:
K_{I}=P_{W}\sqrt{πL}{(1−λₚ)(1−s)[0.637+0.485(1−s)²+0.4s²(1−s)]+λₚ[1+(1−s)[0.5+0.743(1−s)²]]}−Sₕ\sqrt{πL}{0.5(1−λₛ)(3−s)[1+1.243(1−s)³]+λₛ+λₛ(1−s)[0.5+0.743(1−s)²]},
wherein K_{I} is a stress intensity factor of the fracture, P_{w} is a wellbore pressure, L is a fracture length from a wellbore, s=L/(R+L), λₛ=S_{H}/Sₕ, λₚ=Pₚₒᵣₑ/P_{w}, R is a wellbore radius, Sₕ is a minimum in-situ stress, S_{H} is a maximum horizontal in-situ stress, and Pₚₒᵣₑ is a pore pressure.

20. The non-transitory computer readable medium of claim 18, wherein, when the facture is not isolated, determining whether the fracture is stable comprises calculating:
K_{I}=P_{W}\sqrt{πL}[1+(1−s)[0.5+0.743(1−s)²]]−Sₕ\sqrt{πL}{(1−λ)×0.5(3−s)[1+1.243(1−s)³]+λ+λ(1−s)[0.5+0.743(1−s)²]}
wherein K_{I} is a stress intensity factor of the fracture, P_{w} is a wellbore pressure, L is a fracture length from a wellbore, s=L/(R+L), λₛ=S_{H}/Sₕ, λₚ=Pₚₒᵣₑ/P_{w}, R is a wellbore radius, Sₕ is a minimum in-situ stress, S_{H} is a maximum horizontal in-situ stress, and Pₚₒᵣₑ is a pore pressure.
